(19) United States
(12) Patent Application Publication
(10) Pub. No.: US 2002/0191373 A1
(43) Pub. Date: Dec. 19, 2002

(54) Heat dissipation system

(76) Inventor: John W. Williams, Fairfax Station, VA (US)

Correspondence Address: JAMES J. RALABATE, 5792 MAIN STREET, WILLIAMSVILLE, NY, 14221, US

(21) Appl. No.: 09/883,788

(22) Filed: Jun. 18, 2001

(51) Int. Cl. G06F 1/20

(52) U.S. Cl. 361/687

(57) ABSTRACT

The present invention relates to a heat dissipation system for electronic devices and, more particularly, to a system for dissipating heat in electronics using a pressurized non-volatile gas confined within a thermally conductive enclosure.

### TECHNICAL FIELD

The present invention relates to a heat dissipation system for electronic devices and, more particularly, to a system for dissipating heat in electronics using a pressurized non-volatile gas confined within a thermally conductive enclosure.

### BACKGROUND ART

Dissipating heat remains a primary concern for electronics manufacturers, especially computer manufacturers since the central processing unit can reach very high temperatures causing damage to itself and other sensitive electronic components within the same enclosure. For example, an Intel PENTIUM III processor playing a DVD can reach 105° C. The primary cooling mechanism for desktop and laptop computers are heat sinks and fans. However, for computer manufacturers that make wearable or user-supported computers which are limited by power and size, only passive cooling through, for example, heat sinks is available.

It is known in the art to use wearable or user-supported computers that can be operated in a hands-free manner; an example is the MOBILE ASSISTANT by Xybernaut Corporation. An important feature of these computers is that they permit the user to have freedom to use his or her hands for repairing or other manual functions while still able to use a fully functional computer. As above noted, one of the most well known of these user supported computers is the MOBILE ASSISTANT, computer line available from Xybernaut Corporation of Fairfax, Va. MOBILE ASSISTANT is a registered trademark of Xybernaut Corporation. Xybernaut-owned U.S. Pat. Nos. 5,305,244 (Newman I) and U.S. Pat. No. 5,844,824 (Newman II) describe the details and components used in said user-supported computers. U.S. Pat. No. 5,844,824 (Newman II) describes and claims several hands-free activation means and other significant improvements or modifications in user supported computers. Both U.S. Newman I and Newman II are owned by the assignee of the present application and both describe in one embodiment where a rigid computer that has all components in a single housing. The disclosure of U.S. Pat. Nos. 5,305,244 and 5,844,824 are incorporated by reference in the present disclosure.

Other patents describing wearable computers are U.S. Pat. Nos. 5,285,398 (Janik I) and 5,491,651 (Janik II). Both of these patents disclose a non-rigid or a belt worn computer containing the elements or components of a computer in several different housings or pockets. In Janik I, the plurality of computing elements are located in separate pockets on the belt and a flexible signal relaying means connects all of the elements for computing. A protective covering is used for enclosing said computer elements. In Janik II, a similar belt computer is described and claimed in which the signal relaying means, the length of which between any two computing elements, is greater than the length of the wearable member between any two computing elements. In both Janik I and Janik II, the flexible wearable computer is in the form of a belt comprising around its periphery sequentially positioned computer elements.

In desktop and in many mobile computers, including laptops, the computer housings become extremely hot due to the heat generated by the CPU and other internal computer components. Cooling fans are used in larger desktop and laptop computers but space and power precludes their use in wearables. Wearable computers, such as the MOBILE ASSISTANT, must be sealed precluding the use of fans to enable them to be used in adverse weather conditions. Various means such as heat sinks and heat-insulating housings have been considered in wearables to minimize this heat problem but still potential problems exist

Various other cooling techniques are known in the art. In U.S. Pat. No. 5,790,376, Moore discloses a heat dissipation means where the heat generated from a processor is dissipated through an exterior wall of a computer housing by a heat transfer pad structure in which a spaced series of porous plastic tube members, each having a quantity of purified water. However, this method of heat dissipation suffers from the limitation that the water would damage critical electronics if it ever leaked.

In U.S. Pat. Nos. 5,852,548, U.S. 5,898,570, and U.S. 5,999,408, Koon et al discloses a heat transfer structure that includes thermally conductive fibers attached at one end to an external surface of a circuit board and projecting perpendicular to the surface of the board. The heat is conducted away from the circuit board up through the conductive fibers and into a gas surrounding the board. However, these heat dissipation methods are often limited by the rate at which heat can be conducted away from the circuit board and transferred to the surrounding gas. Additionally, there are limits to the number and size of conductive fibers that can be attached to the circuit board.

In U.S. Pat. No. 6,167,947, Hokanson et al discloses a system and method for cooling heat generating devices comprising a sealed enclosure which houses one or more heat generating electronic devices, a blower, and a heat exchanger. The heat which is generated is dissipated by circulating a pressurized gas into and out of the enclosure of the electronic devices. This method suffers from the limitation that the blower is a motorized unit and as such is subject to wear and potential failure.

In U.S. Pat. No. 6,195,267 MacDonald, Jr. et al discloses a heat dissipation system comprising an electronically and thermally conductive gel in contact with heat generating electronic components. The thermally conductive gel may be a silicone elastomer filled with suitable materials to enhance its thermal conductivity including alumina, aluminum nitride, or boron nitride, or combinations thereof. The gel method of dissipating heat suffers from the drawback of potentially damaging any electrical components if the gel container became damaged. Moreover, the gel does not conduct heat as quickly as does a pressured gas.

It is also known to dissipate heat by filling an electronic enclosure with an inert gas to approximately 30 psi thereby balancing the temperature within the enclosure. This method of dissipating heat is effective, but is very expensive to produce. The increased cost of dissipating heat in this manner results in having to pressurize the enclosure and completely seal it including sealing off all ports and connector interfaces. Moreover, if the gas in the enclosure ever leaked, it would need to be re-pressurized and re-sealed. With system taught by the present invention, a failed pressurized flexible thermally conductive enclosure would be much easier and less expensive to repair. Since the electronic enclosure does not need to be sealed, the electronic enclosure can be opened and the pressurized flexible thermally conductive enclosure replaced with a new one.

### SUMMARY OF INVENTION

It is therefore an object of this invention to provide a heat dissipation system which is devoid of the above mentioned shortcomings.

It is another object of this invention to provide a more efficient means to dissipate heat from heat generating devices.

It is still another object of this invention to provide a more cost efficient means to dissipate heat from heat generating devices.

It is still another object of this invention to provide a means for heat dissipation that can be used in existing enclosures as well as designed in on new products.

It is still another object of this invention to provide a means to reduce any concentrated hot spot within a heat generating device.

It is still another object of this invention to provide a passive system for heat dissipation.

These and additional objects of the present invention are accomplished generally by a heat dissipation system wherein the heat is dissipated from a heat generating device. The heat generating device is an enclosure that contains at least one heat source. A flexible thermally conductive enclosure pressurized with a volume of gas, preferably a non-volatile gas and non-toxic gas, such as ammonia, nitrogen, argon, carbon dioxide, air, helium and mixtures, the pressurized gas being greater than an ambient pressure outside the thermally conductive enclosure, is placed in contact with the at least one heat source thereby allowing all sources in contact with the thermally conductive enclose to maintain the same temperature. The enclosure is pressurized to a pressure of 15 to 40 psi, preferably 20 to 30 psi. By elevating the pressure, the density and the heat carrying capacity of the gas within the heat generating device are proportionally increased.

In one embodiment of the present invention, the heat generating device is a housing for electronic device, specifically a housing for a computer comprising a heat source in the form of a central processing unit. A flexible thermally conductive enclosure pressurized with a gas, preferably a non-volatile and non-toxic gas is in thermal contact with all heat sources within the heat generating device and the interior of the computer housing.

In another embodiment of the present invention, the heat generating device is a cellular phone. Cellular phones contain heat sources such as battery charging circuitry and the transceiver. A pressurized flexible thermally conductive enclosure would be placed in contact with the battery charging circuitry as well as any other heat sources within the cellular phone and the interior of the cellular phone case.

In another embodiment of the present invention, the heat generating device is a tablet computer. A tablet computer is an input device that enables the user to enter data, such as drawings or sketches, into a computer. The tablet computer consists of an electronic tablet and a cursor or pen. The tablet contains electronics that enable it to detect movement of the cursor or pen and translate that movement into digital signals that it sends to the computer. Tablet computers have much of the same electronics as a laptop computer and therefore suffer from the same heat problems due to the central processing unit. A pressurized flexible thermally conductive enclosure would be placed into a tablet computer making contact with all heat sources such as the CPU and with the interior of the tablet enclosure.

The foregoing and additional objects and advantages of the invention together with the structure characteristics thereof, which is only briefly summarized in the foregoing passages, becomes more apparent to those skilled in the art upon reading the detailed description and preferred embodiments, which follow in this specification, taken together with the illustration thereof presented in the representative accompanying drawings.

### BRIEF DESCRIPTION OF THE DRAWINGS

FIG. 1 illustrates the pressurized flexible thermally conductive enclosure.

FIG. 2 illustrates a simplified view of a typical interior of a computer enclosure in use with the pressurized flexible thermally conductive enclosure.

FIG. 3 illustrates another embodiment of the invention where the heat generating device is a cellular phone in use with the pressurized flexible thermally conductive enclosure.

FIG. 4 illustrates still another embodiment of the invention where the heat generating device is a tablet computer in use with the pressurized flexible thermally conductive enclosure.

### DETAILED DESCRIPTION OF THE INVENTION AND PREFERRED EMBODIMENTS

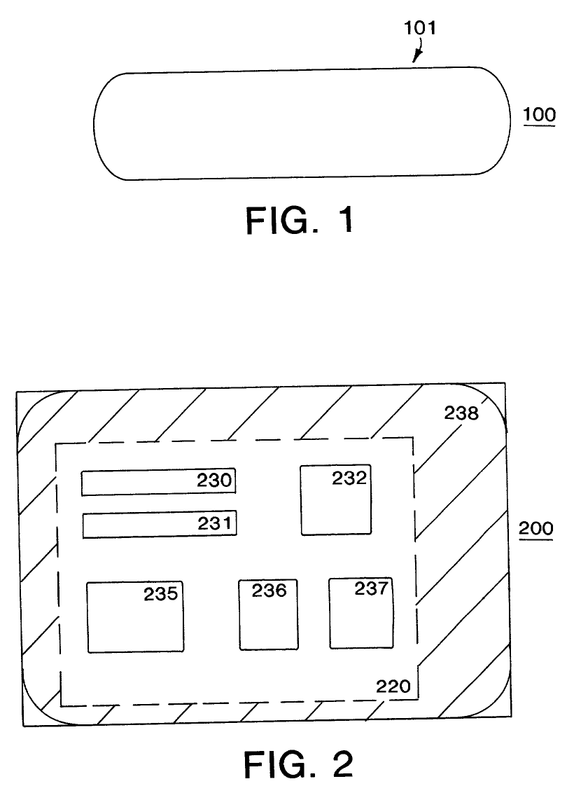

Discussion of the invention will now be made with specific references to the drawing figures. FIG. 1 illustrates the pressurized flexible thermally conductive enclosure indicated by reference number 100. The enclosure is pressurized with a gas, preferably an inert gas, such as ammonia, nitrogen, argon, carbon dioxide, air, helium and mixtures thereof, to a pressure of approximately 15 to 40 psi, preferably 20 to 30 psi and be shaped to fit into existing and future electronic enclosures. The enclosure's outer surface 101 will be composed of at least one layer of a conducting material, preferably copper, silver, gold, or platinum or any other thermally conductive material that exhibits desirable characteristics. In the figures that follow, the thermally conductive enclosure is depicted as a cross hatched section and the heat producing elements in the respective embodiments are shown as though the enclosure overlaying the elements is transparent even though the enclosure fills the entire heat producing device.

FIG. 2 illustrates a simplified view of a typical interior of a computer enclosure. The computer enclosure is indicated generally by reference number 200 and consists generally of at least one computer board 220. The computer board comprises a plurality of heat producing devices such as a central processing unit 232. Other heat producing devices are shown generally by reference numbers 230, 231, 235, 236, and 237 which could be memory in the form of RAM or ROM. The flexible thermally conductive pressurized enclosure 238 is positioned such that the enclosure is in direct contact with all heat producing elements of the heat producing device as well as in contact with the interior of the computer enclosure. The exterior of the pressurized enclosure is a thermally conductive to further facilitate the transfer of heat away from the heat producing devices.

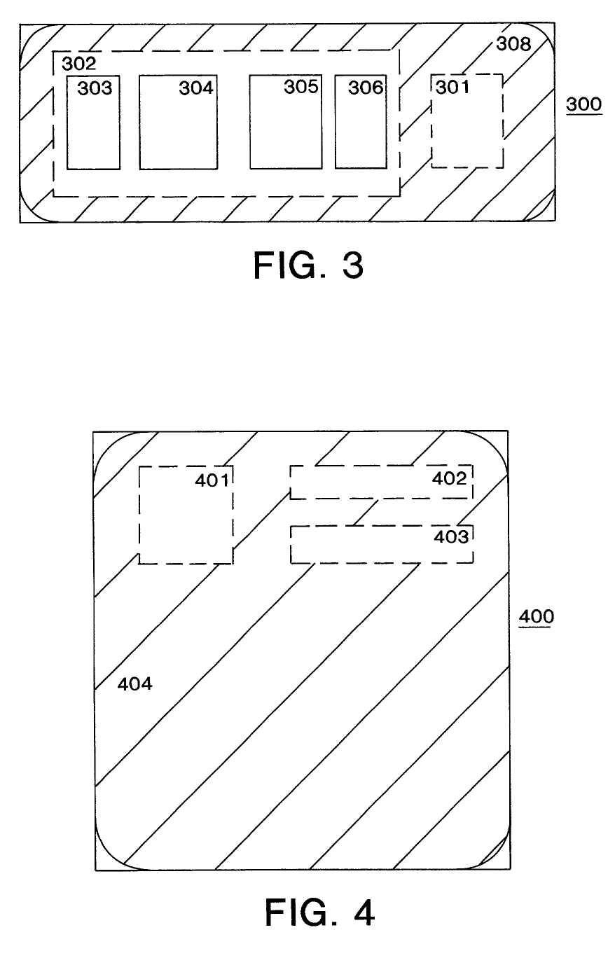

FIG. 3 illustrates an alternative embodiment of the present invention where the heat generating device is a cellular phone. The cellular phone is indicated generally by reference number 300. The cellular phone comprises a pack of electric cells or batters 301, and a telephone circuit 302 powered by the cells 301. The telephone circuit includes transmitter/receiver portion 303, control portion 304, display portion 305, and keyboard portion 306. The flexible thermally conductive pressurized enclosure 308 is positioned such that the enclosure is in direct contact with all heat producing elements of the heat producing device as well as in contact with the interior of the computer enclosure. The exterior of the pressurized enclosure is a thermally conductive to further facilitate the transfer of heat away from the heat producing devices.

FIG. 4 illustrates another alternative embodiment of the present invention where the heat generating device is a tablet computer. The tablet computer is indicated generally by reference number 400. The tablet computer contains much of the same electronic components as does a convention computer, for example a chip set including central processing unit 401, and various forms of memory such as RAM 402 and ROM 403. The flexible thermally conductive pressurized enclosure 404 is positioned such that the enclosure is in direct contact with all heat producing elements of the heat producing device as well as in contact with the interior of the computer enclosure. The exterior of the pressurized enclosure is a thermally conductive to further facilitate the transfer of heat away from the heat producing devices.

The present embodiments of this invention are thus to be considered in all respects as illustrative and not restrictive; the scope of the invention being indicated by the appended claims rather than by the foregoing description. All changes that come within the meaning and range of equivalency of the claims are intended to be embraced therein.

I claim:

1 A heat dissipation system for dissipating heat from a heat generating device, the system comprising:
A heat generating device;
A pliant enclosure pressurized to a first pressure by filling said enclosure with a gas said first pressure being greater than a pressure exterior to said enclosure; said enclosure having at least one layer of thermally conducting material affixed to the exterior of said enclosure wherein said enclosure is in direct physical contact with said heat generating device.

2 The system as in claim 1, wherein said gas is an inert gas.

3 The system as in claim 2, wherein said inert gas is selected from the group consisting of ammonia, nitrogen, helium, carbon dioxide, argon, air and mixtures thereof.

4 The system as in claim 1, wherein said heat generating device is in a wearable computer.

5 The system as in claim 1, wherein said heat generating device is in a cellular telephone.

6 The system as in claim 1, wherein said heat generating device is in a tablet computer.

7 The system as in claim 1, wherein said gas is pressurized in the range of 15 to 40 psi.

8 The system as in claim 1, wherein said gas is pressurized in the range of 20 to 30 psi.

9 The system as in claim 1, wherein said heat generating device is in a communication means comprising a cellular telephone and a general purpose computer.
